(19) United States
(12) Patent Application Publication
(10) Pub. No.: US 2014/0107288 A1
(43) Pub. Date: Apr. 17, 2014

(54) HYDROPHILIC POLYESTER POLYCARBONATE POLYOLS FOR HIGH TEMPERATURE DIESEL APPLICATIONS

(71) Applicants: Harpreet Singh, Pearland, TX (US); Jorge Jimenez, Lake Jackson, TX (US); William H. Heath, Lake Jackson, TX (US); Woo-Sung Bae, Midland, MI (US); Amarnath Singh, Pearland, TX (US)

(72) Inventors: Harpreet Singh, Pearland, TX (US); Jorge Jimenez, Lake Jackson, TX (US); William H. Heath, Lake Jackson, TX (US); Woo-Sung Bae, Midland, MI (US); Amarnath Singh, Pearland, TX (US)

(73) Assignee: Dow Global Technologies LLC, Midland, MI (US)

(21) Appl. No.: 14/005,993

(22) PCT Filed: Mar. 27, 2012
(86) PCT No.: PCT/US12/30689

§ 371 Date: Nov. 26, 2013

Related U.S. Application Data
(60) Provisional application No. 61/470,369, filed on Mar. 31, 2011.

(51) Int. Cl. C08G 63/64; C09D 169/00; C09J 169/00; C08G 18/44

(52) U.S. Cl. CPC C08G 63/64; C08G 18/44; C09D 169/005; C09J 169/005
USPC 524/590; 525/439; 525/440.15

(57) ABSTRACT

Embodiments of the invention generally relate to polyols having resistance to hydrocarbons and articles made therefrom. More specifically, embodiments of the invention generally relate to hydrophilic polyester-polycarbonate polyols having resistance to hydrocarbons at high temperatures and articles made therefrom. The novel hydrophilic polyester-polycarbonate polyols described herein may be used in adhesive or elastomer applications requiring enhanced oil and/or diesel resistance. The disclosed polyols are liquid at room temperature, which facilitates processing into polyurethane products As described herein, an elastomer made from such hydrophilic polyester-polycarbonate polyols and methylene diphenyl diisocyanate (MDI) retained >90% of tensile strength after 500 hours ageing at 121 degrees Celsius. A comparative example made from a polyester polyol retained 50% of tensile strength under similar conditions.

### BACKGROUND OF THE INVENTION

1. Field of the Invention

Embodiments of the invention generally relate to polyols, prepolymers especially prepolymers of isocyanates and the polyols, preferably prepolymers useful for making elastomers as well as polyurethanes made from the polyols combinations thereof having resistance to hydrocarbons and articles made therefrom.

2. Description of the Related Art

Conventional polyurethanes generally have poor resistance to hydrocarbons at high temperatures, such as, temperatures greater than 100 degrees Celsius. That is, most polyurethanes tend to degrade, swell, or dissolve in the presence of hydrocarbons. This property severely restricts the use of articles comprising such conventional polyurethanes used in the presence of hydrocarbons.

Thus it is desirable to provide polyols that are resistant to hydrocarbons at high temperatures.

### SUMMARY OF THE INVENTION

Embodiments of the invention generally relate to polyols, prepolymers especially prepolymers of isocyanates and the polyols, preferably prepolymers useful for making elastomers as well as polyurethanes made from the polyols, the prepolymers or combinations thereof having resistance to hydrocarbons and articles made therefrom. More specifically, embodiments of the invention generally relate to hydrophilic polyester-carbonates having resistance to hydrocarbons at high temperatures and articles made therefrom. In one embodiment a hydrophilic polyester-polycarbonate polyol is provided. The hydrophilic polyester-polycarbonate polyol is the reaction product of (a) a polyester polyol and (b) one or more polycarbonate polyols. The polyester polyol (a) is the reaction product of (i) one or more organic acids and (ii) one or more glycols having a functionality of two or more. The hydrophilic polyester-polycarbonate polyol may include one or more of the following aspects:
one or more organic acids are selected from phthalic acid, isophthalic acid, terephthalic acid, trimellitic acid, tetrahydrophthalic acid, hexahydrophthalic acid, tetrachlorophthalic acid, oxalic acid, adipic acid, azelaic acid, sebacic acid, succinic acid, malic acid, glutaric acid, malonic acid, pimelic acid, suberic acid, 2,2-dimethylsuccinic acid, 3,3-dimethylglutaric acid, 2,2-dimethylglutaric acid, maleic acid, fumaric acid, itaconic acid, or fatty acids; and
one or more glycols having a functionality of two or more are selected from ethylene glycol, propylene glycol-(1,2) and propylene glycol-(1,3), diol-(1,8), neopentyl glycol, 1,3-cyclohexanedimethanol, 1,4-cyclohexanedimethanol (CHDM), 2-methyl-1,3-propane diol, glycerin, trimethylolpropane, hexanetriol-(1,2,6) butane triol-(1,2,4), trimethylolethane, pentaerythritol, quinitol, mannitol and sorbitol, methylglycoside, also diethylene glycol, triethylene glycol, tetrathylene glycol, polyethylene glycols, dibutylene glycol, and polybutylene glycols;
one organic acid is adipic acid and one or more glycols is glycerin and diethylene glycol;
one or more polycarbonates comprise (a) repeating units from one or more alkane diols having 2 to 50 carbon atoms with a number average molecular weight between 500 and 3,000, and (b) at least one carbonate compound selected from alkylene carbonates, diaryl carbonates, dialkyl carbonates, dioxolanones, hexanediol bis-chlorocarbonates, phosgene, urea, and combinations thereof;
one or more alkane diols selected from 1,4-butanediol, 1,5-pentanediol, 1,6-hexandiol, 1,7-heptanediol, 1,2-dodecanediol, cyclohexanedimethanol, 3-methyl-1,5-pentanediol, 2,4-diethyl-1,5-pentanediol, bis(2-hydroxyethyl)ether, bis(6-hydroxyhexyl)ether or short-chain C₂, C₃ or C₄ polyether diols having a number average molecular weight of less than 700 g/mol; and
at least one carbonate compound selected from alkylene carbonates, diaryl carbonates, dialkyl carbonates, dioxolanones, hexanediol bis-chlorocarbonates, phosgene, or urea.

Also disclosed is a hydrocarbon resistant prepolymer or elastomer prepared from a reaction mixture comprising (a) a hydrophilic polyester-polycarbonate polyol, and (b) one or more organic polyisocyanate components. The reaction mixtures may include one or more of the following aspects:
the hydrophilic polyester-polycarbonate polyol comprises (i) a polyester polyol which is the reaction product of one or more organic acids and one or more glycols having a functionality of two or more and (ii) one or more polycarbonate polyols;
the reaction mixture further comprises a chain extender;
the one or more organic acids is adipic acid and the one more glycols is glycerin and diethylene glycol;
the one or more organic polyisocyanate components are selected from polymeric polyisocyanates, aromatic isocyanates, cycloaliphatic isocyanates, or aliphatic isocyanates;
the one or more organic polyisocyanate components is a polymethylene polyphenylisocyanate that contains diphenylmethane diisocyanate (MDI);
an article comprising the hydrophilic prepolymer or elastomer, wherein the article is selected from filter caps, conduits, containers, seals, mechanical belts, liners, coatings, rollers and machine parts; and
a coating, adhesive or binding composition comprising the hydrophilic prepolymer or elastomer.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 represents a perspective view of one embodiment of a filter;

FIG. 2 represents a perspective view of one embodiment of the endcaps of the filter of FIG. 1;

FIG. 3 represents a perspective view of one embodiments of a gasket;

FIG. 4 represents a cutaway perspective view of one embodiment of a lined chute;

FIG. 5 represents a perspective view of one embodiments of a roller;

FIG. 6 represents a perspective view of one embodiment of a mechanical belt;

FIG. 7 represents a perspective view of one embodiment of a gear;

FIG. 8 represents a perspective view of one embodiment of a gear having an outer layer, partially in section;

FIG. 9 represents a perspective view of one embodiment of a conduit;

FIG. 10 represents a perspective view of one embodiment of a container;

FIG. 11 is a plot depicting viscosity verses temperature for a polyester-polycarbonate polyol formed according to embodiments described herein and a butanediol based polycarbonate ester copolymer (BDPC);

FIG. 12 is a GPC chromatogram of a polyester-polycarbonate formed according to embodiments described herein;

FIG. 13 is a plot depicting the retention in tensile strength after a diesel ageing test for samples of elastomers made using BDPC, polyester polyol, a physical blend of a polyester and a polycarbonate polyol, and a polyester-polycarbonate polyol formed according to embodiments described herein; and

FIG. 14 is a plot depicting the diesel uptake after the ageing test for samples of elastomers made using BDPC, a polyester polyol, a physical blend of a polyester and a polycarbonate polyol, and a polyester-polycarbonate polyol formed according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention generally relate to polyols having resistance to hydrocarbons and articles made therefrom. More specifically, embodiments of the invention generally relate to hydrophilic polyester-polycarbonate polyols having resistance to hydrocarbons at high temperatures and articles made therefrom. The novel hydrophilic polyester-polycarbonate polyols described herein may be used in adhesive or elastomer applications requiring enhanced oil and/or diesel resistance. The disclosed polyols are liquid at room temperature, which facilitates processing into polyurethane products. As described herein, an elastomer made from such hydrophilic polyester-polycarbonate polyols and methylene diphenyl diisocyanate (MDI) retained >90% of tensile strength after 500 hours ageing in diesel at 121 degrees Celsius. A comparative example made from a polyester polyol retained 50% of tensile strength under similar conditions.

Filter caps for diesel filters used in heavy machinery are made from elastomers that require good resistance to diesel at high temperatures. Current offerings in the market are based on either polyether polyols or hydrophilic polyester polyols. These options provide good resistance at temperatures as high as 100 degrees Celsius but often degrade upon exposure to hydrocarbons at higher temperatures. In some applications, there is a need to have materials that withstand diesel exposure at temperatures up to at least 120 degrees Celsius. Both polyether polyol and polyester polyol elastomers fail to provide the required resistance at 120 degrees Celsius. One class of polyols that meets the high temperature requirement is polycarbonate polyols such as hexanediol polycarbonate polyols. However, polycarbonates are expensive, are typically solid at room temperature and have high heat of melting. Thus, there is a need for polyols that have the processability benefits of polyether polyols and the enhanced hydrocarbon resistance of polycarbonate polyols.

The embodiments described herein include polyols and copolymers that contain ether, ester and carbonate linkages. This novel class of polyester-polycarbonate polyols is designed with a functionality of 2 or higher and is liquid at room temperature. Elastomers made with such materials exhibit low diesel uptake and retain >90% properties even at high temperatures such as 120 degrees Celsius or greater. Such polyols may be made by transesterification of hydrophilic polyesters (made, for example, from adipic acid, diethylene glycol and glycerin) and aliphatic polycarbonate polyols. Although a physical blend of a polyester and a polycarbonate polyol leads to poor mechanical properties and poor diesel resistance, incorporation of both ester and carbonate linkages into one copolymer leads to good mechanical performance.

The term “prepolymer” as used herein designates a reaction product of polyol with excess isocyanate which has remaining reactive isocyanate functional groups to react with additional isocyanate reactive groups to form a polymer.

The term “elongation” as applied to a polymer not in the form of a foam is used herein to refer to the percentage that the material specified can stretch (extension) without breaking. The result is expressed as a percentage of the original length of the polymer sample and is tested in accordance with the procedures of ISO 37:1994 unless stated otherwise.

The term “tensile strength” as applied to a polymer not in the form of a foam is used herein to refer to a measure of how much stress that the material specified can endure before suffering permanent deformation. The result is typically expressed in Pascals (Pa) or pounds per square inch (psi) and is tested in accordance with the procedures of ISO 37:1994 unless stated otherwise.

The term “NCO Index” means isocyanate index, and is the equivalents of isocyanate, divided by the total equivalents of isocyanate-reactive hydrogen containing materials, multiplied by 100. Considered in another way, it is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

As used herein, “polyol” refers to an organic molecule having an average of greater than 1.0 hydroxyl groups per molecule. It may also include other functionalities, that is, other types of functional groups.

The term “hydroxyl number” indicates the concentration of hydroxyl moieties in a composition of polymers, particularly polyols. A hydroxyl number represents mg KOH/g of polyol. A hydroxyl number is determined by acetylation with pyridine and acetic anhydride in which the result is obtained as the difference between two titrations with KOH solution. A hydroxyl number may thus be defined as the weight of KOH in milligrams that will neutralize the acetic anhydride capable of combining by acetylation with 1 gram of a polyol. A higher hydroxyl number indicates a higher concentration of hydroxyl moieties within a composition.

The term “functionality” particularly “polyol functionality” is used herein to refer to the average number of active hydroxyl groups on a polyol molecule.

In one embodiment, a hydrophilic polyester-polycarbonate polyol which is the reaction product of (a) a polyester polyol and (b) one or more polycarbonate polyols is provided.

Component (a) includes one or more polyester poloyls. Suitable polyester polyols are well known in the industry. Illustrative of such suitable polyester polyols are those produced by reacting a dicarboxylic acid and/or monocarboxylic acid with an excess of a diol and or polyhydroxy alcohol. The one or more polyester polyols made by the reaction product of (i) one or more organic acids and (ii) one or more glycols or polyglycols having a functionality of two or more.

The one or more organic acids (i) may be selected from the group comprising for example, phthalic acid, isophthalic acid, terephthalic acid, trimellitic acid, tetrahydrophthalic acid, hexahydrophthalic acid, tetrachlorophthalic acid, oxalic acid, adipic acid, azelaic acid, sebacic acid, succinic acid, malic acid, glutaric acid, malonic acid, pimelic acid, suberic acid, 2,2-dimethylsuccinic acid, 3,3-dimethylglutaric acid, 2,2-dimethylglutaric acid, maleic acid, fumaric acid, itaconic acid, fatty acids (linolic, oleic and the like) and combinations thereof. The one or more organic acids may be aliphatic acids, aromatic acids, or combinations thereof. Anhydrides of the above acids, where they exist, can also be employed. In addition, certain materials which react in a manner similar to acids to form polyester polyol oligomers are also useful. Such materials include lactones such as caprolactone, and methylcaprolactone, and hydroxy acids such as tartaric acid and dimethylolpropionic acid. If a triol or higher hydric alcohol is used, a monocarboxylic acid, such as acetic acid, may be used in the preparation of the polyester polyol oligomer, and for some purposes, such as polyester polyol oligomer may be desirable. Polyester polyol oligomers which normally are not hydrophilic within the above definition but which can be rendered hydrophilic by appropriate techniques, for example, oxyalkylation utilizing ethylene oxide and propylene oxide are considered to be hydrophilic polyols in the context of the present invention. Preferably, the one or more organic acids is adipic acid.

The one or more glycols or polyglycols having a functionality of two or more (ii) may be selected from the group comprising for example, ethylene glycol, propylene glycol-(1,2) and propylene glycol-(1,3), diol-(1,8), neopentyl glycol, cyclohexane dimethanol (1,4-bis-hydroxymethylcyclohexane), 2-methyl-1,3-propane diol, glycerine, trimethylolpropane, hexanetriol-(1,2,6) butane triol-(1,2,4), trimethylolethane, pentaerythritol, quinitol, mannitol and sorbitol, methylglycoside, also diethylene glycol, triethylene glycol, tetrathylene glycol, polyethylene glycols, dibutylene glycol, polybutylene glycols, and combinations thereof. The one or more glycols or polyglycols having a functionality of two or more preferably include diethylene glycol and glycerine.

Preferably, the hydrophilic polyester polyol is made by reacting adipic acid and diethylene glycol with a glycerine initiator. Exemplary polyester polyols are available as STEPANPOL™ AA60 from the Stepan Company.

The polyester polyol (a) may comprise at least 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, or 90 wt. % of the hydrophilic polyester-polycarbonate polyol. The polyester polyol (a) may comprise up to 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the hydrophilic polyester-polycarbonate polyol.

Component (b) may comprise one or more polycarbonate polyols. The one or more polycarbonate polyols may comprise repeating units from one or more alkane diols having 2 to 50 carbon atoms. The one or more polycarbonate polyols may comprise repeating units from one or more alkane diols having 2 to 20 carbon atoms. The one or more polycarbonate polyols may be difunctional polycarbonate polyols.

The one or more polycarbonate polyols may have a number average molecular weight from about 500 to about 5,000, preferably, from about 500 to about 3,000, more preferably, from about 1,800 to about 2,200.

The one or more polycarbonate polyols may have a hydroxyl number average from about 22 to about 220 mg KOH/g, for example, from about 51 to 61 mg KOH/g.

The one or more polycarbonate polyols may have a viscosity from about 4,000 to about 15,000 centipose (cp) measured at 60 degrees Celsius by parallel plate rheometry.

The one or more polycarbonate polyols (b) may be prepared by reacting at least one polyol mixture comprising (i) one or more alkane diols (ii) with at least one organic carbonate. The one or more polycarbonate polyols may be obtained by subjecting the at least one polyol mixture and the at least one carbonate compound to a polymerization reaction. With respect to the method for performing the polymerization reaction, there is no particular limitation, and the polymerization reaction can be performed by using conventional methods known in the art.

The one or more alkane diols (i) may be selected from the group comprising: aliphatic diols having 2 to 50 carbon atoms in the chain (branched or unbranched) which may also be interrupted by additional heteroatoms such as oxygen (O), sulphur (S) or nitrogen (N). Examples of suitable diols are 1,3-propanediol, 1,4-butanediol, 1,5-pentanediol, 1,6-hexandiol, 1,7-heptanediol, 1,2-dodecanediol, cyclohexanedimethanol, 3-methyl-1,5 -pentanediol, 2,4-diethyl-1,5-pentanediol, bis(2-hydroxyethyl)ether, bis(6-hydroxyhexyl)ether or short-chain C₂, C₃ or C₄ polyether diols having a number average molecular weight of less than 700 g/mol, combinations thereof, and isomers thereof.

The at least one carbonate compound (ii) may be selected from alkylene carbonates, diaryl carbonates, dialkyl carbonates, dioxolanones, hexanediol bis-chlorocarbonates, phosgene and urea. Examples of suitable alkylene carbonates may include ethylene carbonate, trimethylene carbonate, 1,2-propylene carbonate, 5-methyl-1,3-dioxane-2-one, 1,2-butylene carbonate, 1,3-butylene carbonate, 1,2-pentylene carbonate, and the like. Examples of suitable dialkyl carbonates may include dimethyl carbonate, diethyl carbonate, di-n-butyl carbonate, and the like and the diaryl carbonates may include diphenyl carbonate.

The polymerization reaction for the polycarbonate polyol may be aided by a catalyst. With respect to the method for performing the polymerization reaction, there is no particular limitation, and the polymerization reaction can be performed by using conventional methods known in the art. The polymerization reaction may be a transesterification reaction. In a transesterification reaction, one preferably contacts reactants in the presence of a transesterification catalyst and under reaction conditions. In principle, all soluble catalysts which are known for transesterification reactions may be used as catalysts (homogeneous catalysis), and heterogeneous transesterification catalysts can also be used. The process according to the invention is preferably conducted in the presence of a catalyst.

Hydroxides, oxides, metal alcoholates, carbonates and organometallic compounds of metals of main groups I, II, III and IV of the periodic table of the elements, of subgroups III and IV, and elements from the rare earth group, particularly compounds of Ti, Zr, Pb, Sn and Sb, are particularly suitable for the processes described herein.

Suitable examples include: LiOH, Li₂CO₃, K₂CO₃, KOH, NaOH, KOMe, NaOMe, MeOMgOAc, CaO, BaO, KOt-Bu, TiCl₄, titanium tetraalcoholates or terephthalates, zirconium tetraalcoholates, tin octoate, dibutyltin dilaurate, dibutyltin, bistributyltin oxide, tin oxalate, lead stearate, antimony trioxide, and zirconium tetraisopropylate.

Aromatic nitrogen heterocycles can also be used in the process described herein, as can tertiary amines corresponding to R₁R₂R₃N, where R₁₋₃ independently represents a C₁-C₃₀ hydroxyalkyl, a C₄-C₃₀ aryl or a C₁-C₃₀ alkyl, particularly trimethylamine, triethylamine, tributylamine, N,N-dimethylcyclohexylamine, N,N-dimethyl-ethanolamine, 1,8-diaza-bicyclo-(5.4.0)undec-7-ene, 1 ,4-diazabicyclo-(2.2.2)octane, 1,2-bis(N,N-dimethyl-amino)-ethane, 1 ,3-bis(N-dimethyl-amino)propane and pyridine.

Alcoholates and hydroxides of sodium and potassium (NaOH, KOH, KOMe, NaOMe), alcoholates of titanium, tin or zirconium (e.g. Ti(OPr)₄), as well as organotin compounds may also be used, wherein titanium, tin and zirconium tetraalcoholates may be used with diols which contain ester functions or with mixtures of diols with lactones.

The amount of catalyst present depends on the type of catalyst. In certain embodiments described herein, the homogeneous catalyst is used in concentrations (expressed as percent by weight of metal with respect to the aliphatic diol used) of up to 1,000 ppm (0.1%), preferably between 1 ppm and 500 ppm (0.05%), most preferably between 5 ppm and 100 ppm (0.01%). After the reaction is complete, the catalyst may be left in the product, or can be separated, neutralized or masked. The catalyst may be left in the product.

Temperatures for the transesterification reaction may be between 120 degrees Celsius and 240 degrees Celsius. The transesterification reaction is typically performed at atmospheric pressure but lower or higher pressures may be used. Vacuum may be applied at the end of the activation cycle to remove any volatiles. Reaction time depends on variables such as temperature, pressure, type of catalyst and catalyst concentration.

Exemplary polycarbonate polyols comprising repeating units from one or more alkane diol components are available from Arch Chemicals, Inc., under the trade name Poly-CD™ 220 carbonate diol and from Bayer MaterialScience, LLC, under the tradename DESMOPHEN® polyols.

The one or more polycarbonate polyols (b) may comprise at least 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, or 90 wt. % of the hydrophilic polyester-polycarbonate polyol. The one or more polycarbonate polyols (b) may comprise up to 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the hydrophilic polyester-polycarbonate polyol.

The polyester-polycarbonate polyol may be prepared by subjecting the one or more polyols (a) and the one or more polycarbonate polyols (b) to a polymerization reaction. The polymerization reaction may be a transesterification reaction. In principle, all soluble catalysts which are known for transesterification reactions may be used as catalysts (homogeneous catalysis), and heterogeneous transesterification catalysts can also be used. The exemplary catalysts described above for formation of the polycarbonate polyol may also be used for formation of the polyester-polycarbonate polyol.

As described above, temperatures for the transesterification reaction may be between 120 degrees Celsius and 240 degrees Celsius. The transesterification reaction is typically performed at atmospheric pressure but lower or higher pressures may also be useful. Vacuum may be applied at the end of the activation cycle to remove any volatiles. Reaction time depends on variables such as temperature, pressure, type of catalyst and catalyst concentration. In certain embodiments, where titanium catalysts are used in the production of the polycarbonate polyol, any residual titanium catalyst in the polycarbonate may assist with the transesterification reaction for formation of the polyester-polycarbonate polyol.

Prepolymer or Elastomer Composition:

In another embodiment, a hydrocarbon resistant prepolymer or elastomer is provided. The elastomer or prepolymer is prepared from a reaction system comprising (a) a hydrophilic polyester-polycarbonate polyol and (b) one or more organic polyisocyanates.

Component (a) may comprise the hydrophilic polyester-polycarbonate polyol as previously described herein.

The hydrophilic polyester-polycarbonate polyol (a) may comprise at least 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, or 90 wt. % of the elastomer composition. The hydrophilic polyester-polycarbonate polyol (a) may comprise up to 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the elastomer composition.

Component (b) may comprise one or more organic polyisocyanate components. The isocyanate functionality is preferably from about 1.9 to 4, and more preferably from 1.9 to 3.5 and especially from 2.0 to 3.3. The one or more organic polyisocyanate components may be selected from the group comprising a polymeric polyisocyanate, aromatic isocyanate, cycloaliphatic isocyanate, or aliphatic isocyanates Exemplary polyisocyanates include, for example, m-phenylene diisocyanate, 2,4- and/or 2,6-toluene diisocyanate (TDI), the various isomers of diphenylmethanediisocyanate (MDI), and polyisocyanates having more than 2 isocyanate groups, preferably MDI and derivatives of MDI such as biuret-modified “liquid” MDI products and polymeric MDI (PMDI), 1,3 and 1,4-(bis isocyanatomethyl)cyclohexane, isophorone diisocyanate (IPDI), hexamethylene diisocyanate (HDI), bis(4-isocyanatocyclohexyl)methane or 4,4′ dimethylene dicyclohexyl diisocyanate (H12MDI), and combinations thereof, as well as mixtures of the 2,4- and 2,6-isomers of TDI, with the former most preferred in the practice of the invention. A 65/35 weight percent mixture of the 2,4 isomer to the 2,6 TDI isomer is typically used, but the 80/20 weight percent mixture of the 2,4 isomer to the 2,6 TDI isomer is also useful in the practice of this invention and is preferred based on availability. Suitable TDI products are available under the trade name VORANATE™ which is available from The Dow Chemical Company. Preferred isocyanates include methylene diphenyl diisocyanate (MDI) and or its polymeric form (PMDI) for producing the prepolymers described herein. Such polymeric MDI products are available from The Dow Chemical Company under the trade names PAPI® and VORANATE®. Suitable commercially available products of that type include PAPI™ 94 and PAPI™ 27 which are available from The Dow Chemical Company.

The one or more organic polyisocyanate components (b) may comprise at least 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, or 90 wt. % of the elastomer composition. The one or more organic polyisocyanate components (b) may comprise up to 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the elastomer composition.

For elastomers, coating and adhesives the isocyanate index is generally between 80 and 125, preferably between 90 to 110. For prepolymers the isocyanate index is generally between 200 and 5,000, preferably between 200 to 2,000.

The reaction system may further comprise one or more chain extenders (c). A chain extender is a material having two isocyanate-reactive groups per molecule. In either case, the equivalent weight per isocyanate-reactive group can range from about 30 to less than 100, and is generally from 30 to 75. The isocyanate-reactive groups are preferably aliphatic alcohol, primary amine or secondary amine groups, with aliphatic alcohol groups being particularly preferred. The chain extender is typically used in small quantities such as up to 10 wt. %, especially up to 3 wt. % of the total reaction system. In certain embodiments, the chain extender is from 0.015 to 5 wt. % of the total reaction system. Representative chain extenders include ethylene glycol, diethylene glycol, 1,3-propane diol, 1,3-butanediol, 1,4-butanediol, dipropylene glycol, 1,2-butylene glycol, 2,3-butylene glycol, 1,6-hexanediol, neopentylglycol, tripropylene glycol, 1,2-ethylhexyldiol, ethylenediamine, 1,4-butylenediamine, 1,6-hexamethylenediamine, 1,5-pentanediol, 1,3-cyclohexandiol, 1,4-cyclohexanediol; 1,3-cyclohexane dimethanol, 1,4-cyclohexane dimethanol, N-methylethanolamine, N-methyliso-propylamine, 4-aminocyclohexanol, 1,2-diaminotheane, 1,3 -diaminopropane, hexylmethylene diamine, methylene bis(aminocyclohexane), isophorone diamine, 1,3-bis(aminomethyl), 1,4-bis(aminomethyl)cyclohexane, diethylenetriamine, 3,5-diethyltoluene-2,4-diamine and 3,5-diethyltoluene-2,6-diamine, and mixtures or blends thereof. Suitable primary diamines include for example dimethylthiotoluenediamine (DMTDA) such as Ethacure 300 from Albermarle Corporation, diethyltoluenediamine (DETDA) such as Ethacure 100 from Albemarle (a mixture of 3,5-diethyltoluene-2,4-diamine and 3,5-diethyltoluene-2,6-diamine), isophorone diamine (IPDA), and dimethylthiotoluenediamine (DMTDA).

The reaction system may further comprise one or more catalyst components (d). Catalysts are typically used in small amounts, for example, each catalyst being employed from 0.0015 to 5 wt. % of the total reaction system. The amount depends on the catalyst or mixture of catalysts and the reactivity of the polyols and isocyanate as well as other factors familiar to those skilled in the art.

Although any suitable catalyst may be used. A wide variety of materials are known to catalyze polyol reactions including amine-based catalysts and tin-based catalysts. Preferred catalysts include tertiary amine catalysts and organotin catalysts. Examples of commercially available tertiary amine catalysts include: trimethylamine, triethylamine, N-methylmorpholine, N-ethylmorpholine, N,N-dimethylbenzylamine, N,N-dimethylethanolamine, N,N-dimethylaminoethyl, N,N,N′,N′-tetramethyl-1,4-butanediamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of these tertiary amine catalysts are often used.

Examples of commercially available amine catalysts include NIAX™ A1 and NIAX™ A99 (bis(dimethylaminoethyl)ether in propylene glycol available from Momentive Performance Materials), NIAX™ B9 (N,N-dimethylpiperazine and N—N-dimethylhexadecylamine in a polyalkylene oxide polyol, available from Momentive Performance Materials), DABCO® 8264 (a mixture of bis(dimethylaminoethyl)ether, triethylenediamine and dimethylhydroxyethyl amine in dipropylene glycol, available from Air Products and Chemicals), DABCO® 33LV (triethylene diamine in dipropylene glycol, available from Air Products and Chemicals), DABCO® BL-11 (a 70% bis-dimethylaminoethyl ether solution in dipropylene glycol, available from Air Products and Chemicals, Inc), NIAX™ A-400 (a proprietary tertiary amine/carboxylic salt and bis (2-dimethylaminoethyl)ether in water and a proprietary hydroxyl compound, available from Momentive Performance Materials); NIAX™ A-300 (a proprietary tertiary amine/carboxylic salt and triethylenediamine in water, available from Momentive Performance Materials); POLYCAT® 58 (a proprietary amine catalyst available from Air Products and Chemicals), POLYCAT® 5 (pentamethyl diethylene triamine, available from Air Products and Chemicals) POLYCAT® 8 (N,N-dimethyl cyclohexylamine, available from Air Products and Chemicals) and POLYCAT® 41 (a proprietary amine catalyst available from Air Products and Chemicals).

Examples of organotin catalysts are stannic chloride, stannous chloride, stannous octoate, stannous oleate, dimethyltin dilaurate, dibutyltin dilaurate, other organotin compounds of the formula SnRₙ(OR)₄₋ₙ, wherein R is alkyl or aryl and n is 0-2, and the like. Organotin catalysts are generally used in conjunction with one or more tertiary amine catalysts, if used at all. Commercially available organotin catalysts of interest include KOSMOS® 29 (stannous octoate from Evonik AG), DABCO® T-9 and T-95 catalysts (both stannous octoate compositions available from Air Products and Chemicals).

Additives such as surface active agents, antistatic agents, plasticizers, fillers, flame retardants, pigments, stabilizers such as antioxidants, fungistatic and bacteriostatic substances and the like are optionally used in the reaction system.

Embodiments of the present invention are suitable for applications in which the hydrocarbon resistant article is exposed to hydrocarbons preferably when used in the form of hydrocarbon resistant conduits, containers, seals, mechanical belts, linings, coatings, rollers, machine parts and the like. Conduits include, for example, pipes, hoses, tubing, gasoline lines, and the like. Containers include, for example, tanks, bottles, flasks, pans, and the like. Mechanical belts include, for example, belts which transfer energy from such energy sources as engines, turbines and the like to other moving apparatus such as fans, other parts of engines and the like, such as automotive belts, truck belts, pump belts and the like as well as belts used for transport such as conveyor belts and the like. Seals include, for example, gaskets; adhesive seals which serve an adhesive function such as hydrocarbon filter seals including fuel filter endcaps; pipe seals; adhesive construction seals and the like; seals which fill gaps such as construction seals, door seals, window seals, shingle seals, and the like; o-rings, and the like; and any polyurethane article which separates other articles and reduces gaps between said articles. Linings include, for example, linings of conduits, containers and the like, such as linings for hoses, pipes, tubing, tanks, bottles, boilers, pans and the like. Coatings include, for example, surface coverings and other coatings on any object, preferably on an object which may contact or be immersed in hydrocarbons, such a conduit, container, roller, machine part and the like. Machine parts include gears, parts for such equipment as oil field equipment, down-hole equipment, engine parts, pump parts (particularly parts for pumps for petroleum and petroleum products) and the like. Rollers include textile rollers, printing rollers, paper mill rollers, metal processing rollers and the like.

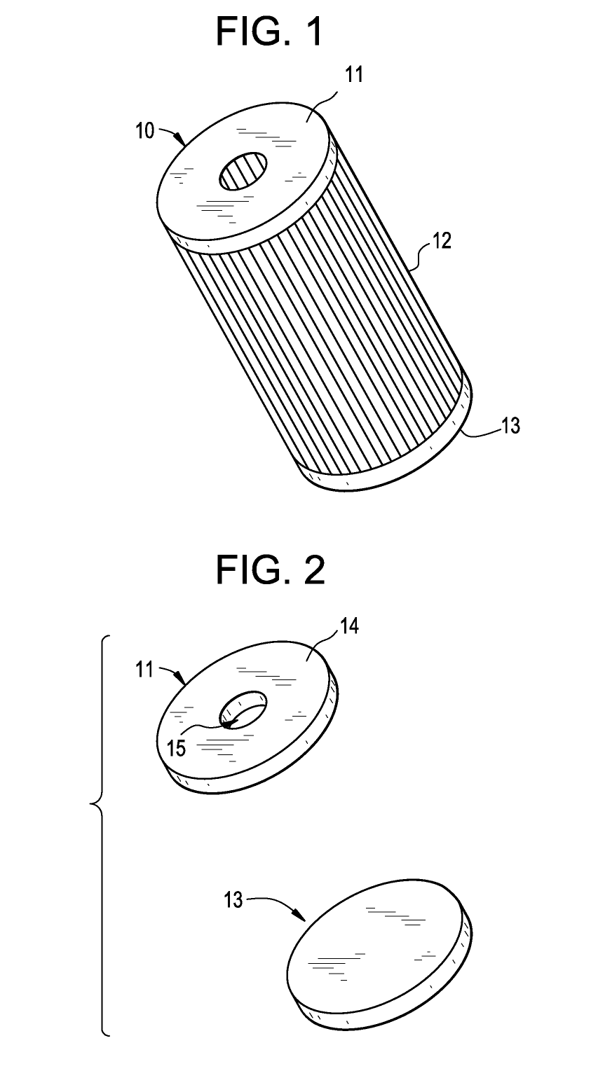

Exemplary of a type of seal of particular utility is a filter endcap for a hydrocarbon filter. A filter endcap is an object which is at one or more ends of a hydrocarbon filter. Advantageously, the filter endcap fits between the filter and a housing for the filter. Preferably, a filter endcap also confines flow of hydrocarbon so that it goes through the filter. Hydrocarbons suitably filtered include petroleum products such as fuels, feedstocks and the like, lubricants, such as oils and the like and other hydrocarbon materials such as solvents, cleaning fluids, and the like. One typical configuration of a filter having two endcaps is shown in FIG. 1. In FIG. 1, there is a cylindrical filter, 12, having a first endcap 11 and a second endcap 13. Filter 12, as illustrated, is a cylindrical pleated paper filter. Other configurations of filters, for example, generally tubular but having any cross section such as square, rectangular, triangular, or other polygonal cross sections are suitable. Also, the material can be any foraminous material suitable for retaining undesirable materials and allowing the desirable hydrocarbons to pass through. Such materials are known to those skilled in the art. While the filter need not be pleated, an arrangement such as pleating, folding or twisting which allows exposure of the hydrocarbon to a larger surface area than is otherwise available is generally preferable. Each endcap is preferably molded to an end of the filter 12. Those skilled in the art can mold such an endcap onto a filter without undue experimentation. Advantageously, the filter is introduced into a mold for the endcap before the endcap-forming formulation completely hardens, preferably before the formulation is introduced into the mold.

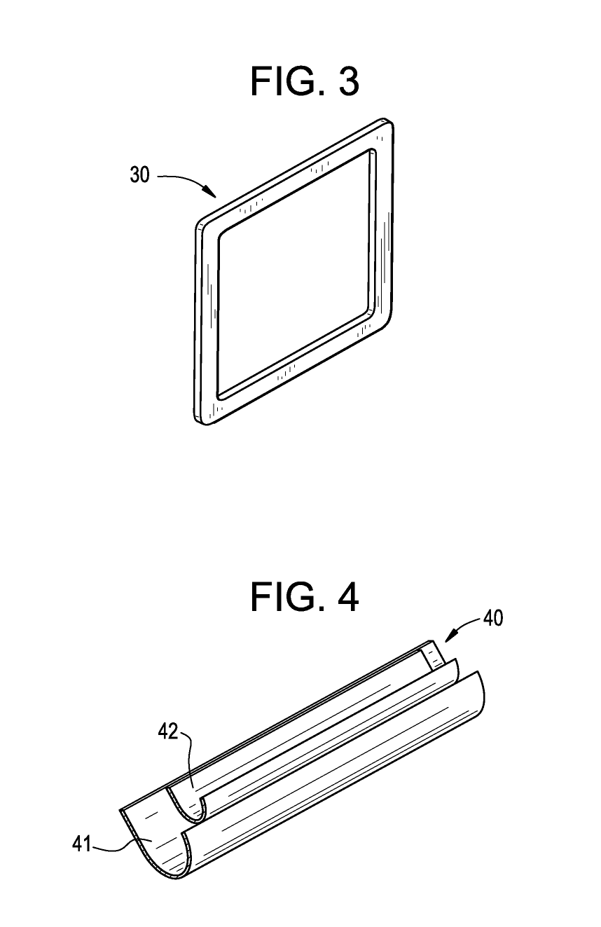

As illustrated in FIG. 2, endcap 11 is of generally a disk shape having a hole 15 generally through the center. The endcap also has an outer surface 14. In the illustrated embodiment, the second endcap 13 has a disk shape without a hole. Endcaps 11 and 13 preferably fit against the filter 12 such that hydrocarbons entering at 15 must flow through the filter 12. There is preferably a housing around the filter. When there is a housing, it would include a means for admitting a hydrocarbon such that an entering hydrocarbon flow would be through hole 15 then through filter 12 to become filtered hydrocarbons. The housing would preferably include a means for confining filtered hydrocarbons such that said hydrocarbons do not mix with incoming hydrocarbons. The housing would also preferably include means for guiding filtered hydrocarbons from the filter.

FIG. 3 represents a perspective view of one embodiment of a gasket 30 according to embodiments described herein. The gasket 30 has a generally rectangular shape and is exemplary of the seals of the invention. Those skilled in the art are able to form seals of the invention without undue experimentation. Preferably the seals are cast or molded.

FIG. 4 represents a cut away perspective view of one embodiment of a lined chute 40 according to embodiments described herein. The chute 40 has a structural member 41 in a curved shape suitable for guiding materials. Structural member 41 is suitably made of any material, preferably one strong enough to retain structural shape and integrity and support the weight of the chute and the materials guided, such as metal or plastic. The chute 40 additionally has a lining 42 suitably formed according to embodiments described herein. The lining 42 is preferably adhered to structural member 41. The lining 42 is exemplary of linings of the invention. Those skilled in the art are able to form linings for conduits, containers and similar articles without undue experimentation.

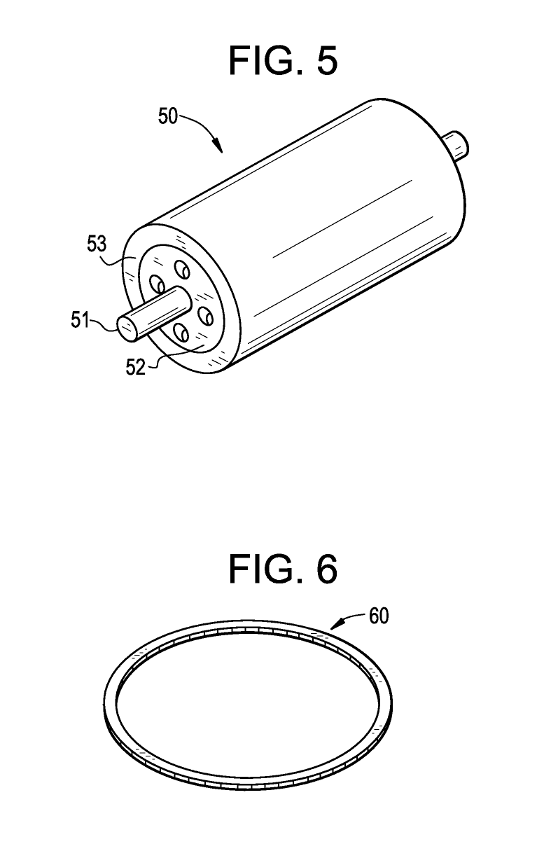

FIG. 5 represents a perspective view of one embodiment of a roller 50 having a shaft 51, an inner cylinder 52 and an outer portion 53. Shaft 51 and inner cylinder 52 are suitably formed from any material suitable for maintaining structural integrity and function. Such materials include metals, plastics and the like. Outer portion 53, and optionally shaft 51 and/or inner cylinder 52 are suitably formed from the hydrocarbon resistant polyester polycarbonate copolymer elastomer described herein. Roller 50 is exemplary of rollers of the invention. Advantageously, a roller has one member serving the combined functions of inner cylinder 52 and outer portion 53, said member being formed of the polyester polycarbonate copolymer elastomer of the invention. Those skilled in the art are able to form rollers of the invention without undue experimentation. Preferably the rollers are cast or molded. Suitably, an outer portion as illustrated by 53 in FIG. 5 may be coated onto an inner cylinder as represented by 52 in FIG. 5.

FIG. 6 represents a perspective view of one embodiment of a mechanical belt 60. The mechanical belt 60 is suitably ring-shaped as illustrated or may have another configuration suitable for use as a belt such as a more oval shape than illustrated. The belt is suitably formed of the hydrocarbon resistant polyester polycarbonate copolymer elastomer described herein. Those skilled in the art are able to form belts of the invention without undue experimentation. Preferably the belts are cast or molded.

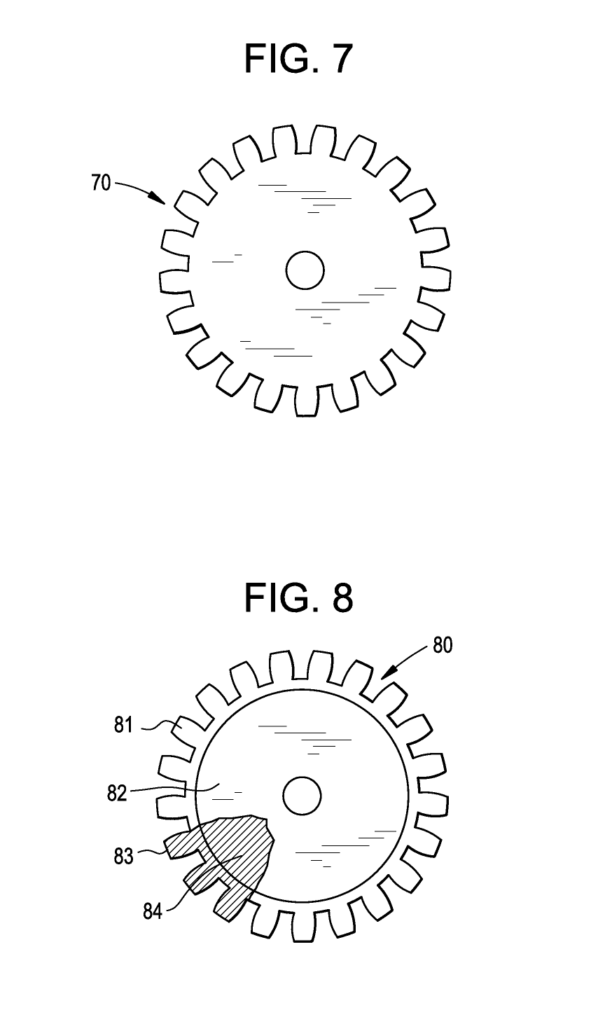

FIG. 7 represents a perspective view of a gear 70 suitably formed of the hydrocarbon resistant polyester polycarbonate copolymer elastomer described herein. Preferably the gears are cast or molded.

FIG. 8 represents a perspective view of one embodiment of a gear 80, having an inner layer 81 and an outer layer 82. The gear 80 is partially cut away illustrating the composition of layer 82 in cut away 84 as metal and illustrating the composition of outer layer 83 as plastic. Outer layer 82 is suitably formed of the hydrocarbon resistant polyester polycarbonate copolymer elastomer described herein. In other embodiments of the invention the inner layer is suitably formed of any material such as a metal or plastic having sufficient strength, hardness and wearing qualities suitable for the function of the gear. Those skilled in the art are able to form gears of the invention without undue experimentation. When there are inner and outer layers of the gear, the gear is preferably formed by compression molding or extrusion.

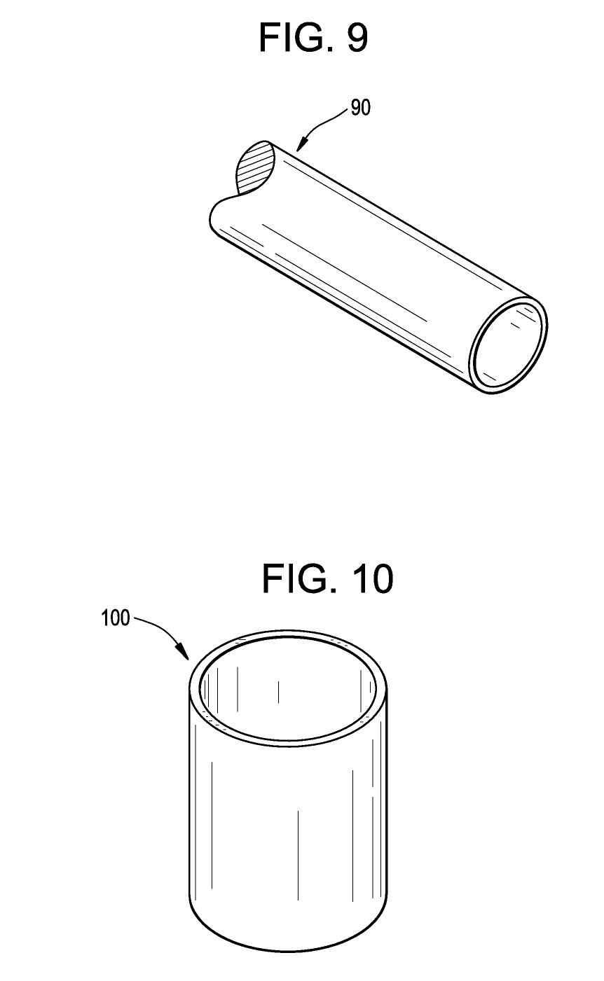

FIG. 9 represents a perspective view of one embodiment of a conduit 90 suitably formed of the hydrocarbon resistant polyester polycarbonate copolymer elastomer described herein.

FIG. 10 represents a perspective view of a container 100 suitably formed of the hydrocarbon resistant polyester polycarbonate copolymer elastomer described herein. Those skilled in the art are able to form conduits and containers of the invention without undue experimentation. Preferably the conduits and containers are cast or molded.

Those skilled in the art will recognize that the hydrocarbon resistant polyester polycarbonate copolymer elastomer described herein is particularly suitable for other applications in which the polymer is exposed to hydrocarbons or other materials which similarly swell commonly-encountered polyurethanes.

### EXAMPLES

Objects and advantages of the embodiments described herein are further illustrated by the following examples. The particular materials and amounts thereof, as well as other conditions and details, recited in these examples should not be used to limit embodiments described herein. Unless stated otherwise all percentages, parts and ratios are by weight. Examples of the invention are numbered while comparative samples, which are not examples of the invention, are designated alphabetically.

A description of the raw materials used in the examples is as follows.

The chain extender is 1,4 butane diol (BDO) which is commercially available from SIGMA-ALDRICH®.

The titanium catalyst is TYZOR® TPT (tetra-isopropyl titanate) catalyst which is a reactive organic alkoxy titanate with 100% active content commercially available from DuPont.

The dimethyl carbonate (DMC) is commercially available from KOWA American Corporation.

Polyol A is a polyester polyol copolymer of adipic acid, diethylene glycol, and glycerine with an average functionality of 2.9 and an equivalent weight of approximately 930 which is commercially available as STEPANPOL™ AA60 from the Stepan Company.

The amine catalyst is a moderately active trimerization catalyst commercially available as POLYCAT® 41 from Air Products and Chemicals.

The isocyanate is polymethylene polyphenylisocyanate that contains MDI, commercially available as PAPI™ 27 polymeric MDI (PMDI) from The Dow Chemical Company.

Synthesis of Butanediol Based PC Polyol (BDPC)

A 1,000 mL four-neck round-bottom flask was equipped with a Dean-Stark trap, thermocouple, and mechanical stirrer. The fourth port was used to add dimethyl carbonate (DMC). The flask was heated with a heating mantle and monitored in the reaction via the thermocouple. 635 g of butane diol (7.055 mol) was added to the flask and was heated to 150 ° C. while sweeping with N₂ to inert the flask and remove water present in the butane diol. TYZOR® TPT catalyst (188 mg) was added via syringe to the reaction flask. DMC was added via peristaltic pump and within 45 minutes DMC and methanol began to distill over at 62 degrees Celsius. In total, 1,079 g of DMC (11.994 mol, 1.7 eq wrt BDO) was added at a rate sufficient to maintain the overhead temperature between 62 to 65 degrees Celsius. Upon completion of the DMC add, the temperature was increased, in 10 degrees Celsius increments, to 200 degrees Celsius. Upon reaching 200 degrees Celsius, the pot temp was immediately reduced to 170 degrees Celsius and a nitrogen sweep was begun (overnight). The molecular weight (Mn) was found to be 3,065 g/mol (pdi 2.28) by GPC analysis and 3,660 g/mol via 1H NMR end-group analysis.

Next 20.86 g of butane diol (BDO) was added to the reaction mixture with stirring at 170 degrees Celsius. After two hours of reaction under these conditions, the Mn was found to be 1,590 g/mol by 1H NMR end-group analysis with 9 mole % carbonate end-groups. The reaction pressure was reduced to 120 torr and the reaction was stirred at 180 degrees Celsius for two hours resulting in an increase in molecular weight to 2,159 g/mol (1H NMR end-group analysis) with 3.9 mole% carbonate end-groups. BDO (3.0 g) was added and the reaction was stirred at 170 degrees Celsius for two hours before reducing the pressure to 80 ton and increasing the temperature to 200 degrees Celsius for an additional two hours. The molecular weight increased to 2,275 g/mol (1H NMR end-group analysis) and the hydroxyl number was determined to be 49.36 mg KOH/g. A final BDO add of 4.0 g was made and the reaction was stirred for an additional two hours at 180 degrees Celsius. The molecular weight was reduced to 1,773 g/mol (1H NMR end-group analysis) and the carbonate end-groups were non-detect by 1H NMR. The hydroxyl number of the final polymer was 55 mg KOH/g.

TABLE I
Butane Diol Polycarbonate (BDPC) Polyol Formulations:

| Raw Materials | Amount | |
|---|---|---|
| Chain Extender | 635 | g |
| Titanium Catalyst | 188 | mg |
| Dimethyl Carbonate | 1079 | g |

Table I: BDPC formulations.

Synthesis of Polyester Polycarbonate (PC Ester) Polyol Via Transesterification Route

600g each of BDPC and STEPANPOL® AA60 polyol was weighed in a 3 L flask. The mixture was heated to 185 degrees Celsius for six hours under nitrogen. The mixture was cooled to 100 degrees Celsius and 0.26 g of dibutyl phosphate was added to quench the residual Ti catalyst. The resulting copolymer was mixed for one hour. Vacuum was applied for 30 minutes to strip off any volatiles. The hydroxyl number of the final copolymer was measured at approximately 56.

TABLE II
Polyester Polycarbonate (PC ester) Formulations:

| Raw Materials | Amount | |
|---|---|---|
| BDPC | 600 | g |
| Polyol A | 600 | g |
| Dibutyl Phosphate | 0.26 | g |

Table II: PC ester formulations.

Elastomer Casting

50 g of copolymer (PC Ester), 6 g of butanediol and 0.7 g of POLYCAT®41 catalyst was mixed at 70 degrees Celsius in a FLACKTEK™ mixer for twenty seconds at 2,350 rpm. 25 g of PAPI™27 isocyante was then added and the mixture was further mixed for twenty seconds. The final isocyanate polyol mixture was poured between two TEFLON® coated aluminum pans and compression molded at 80 degrees Celsius for thirty minutes. The plaque was removed from the mold and cured overnight in an 80 degrees Celsius air oven.

TABLE III
Elastomer Formulations:

| | | | Comparative | | Comparative | | Comparative | |
|---|---|---|---|---|---|---|---|---|
| Raw Materials | Example 1 | | Sample A | | Sample B | | Sample C | |
| PC ester | 50 | g | | | | | | |
| copolymer | | | | | | | | |
| BDPC | | | 50 | g | | | 25 | g |
| Polyol A | | | | | 50 | g | 25 | g |
| Chain Extender | 6 | g | 6 | g | 6 | g | 6 | g |
| Amine Catalyst | 0.1 | g | 0.1 | g | 0.1 | g | 0.1 | g |
| Isocyanate | 25.2 | g | 25.2 | g | 25.2 | g | 25.2 | g |

Table III: Elastomer Formulations.

Elastomers with pure butanediol PC (BDPC) (Comparative Sample A), Stepanpol AA60 (Comparative Sample B) and a 50-50 physical blend of butanediol PC and Stepanpol AA60 (Comparative Sample C) were made in a similar fashion for comparison.

The tensile properties of the elastomers were obtained on microtensile bar samples that were punched out from the plaques. The microtensile bar samples were dogbone shaped with a width of 0.815″ and length of 0.827″. The tensile properties were measured using a Monsanto Tensometer available from Alpha technologies. The bar samples were clamped pneumatically and pulled at a strain rate of 5″/min

Bar samples from the BDPC elastomer, the polyester elastomer, and from the elastomer made with the physical blend BDPC and Stepanpol AA60 were submerged in Diesel #2 fuel at 121° C. for twenty days. The change in the weight of the dog bones due to diesel absorption and the tensile properties were monitored. The bar samples were dried in an 80 degrees Celsius air oven for six hours before the tensile strength measurement.

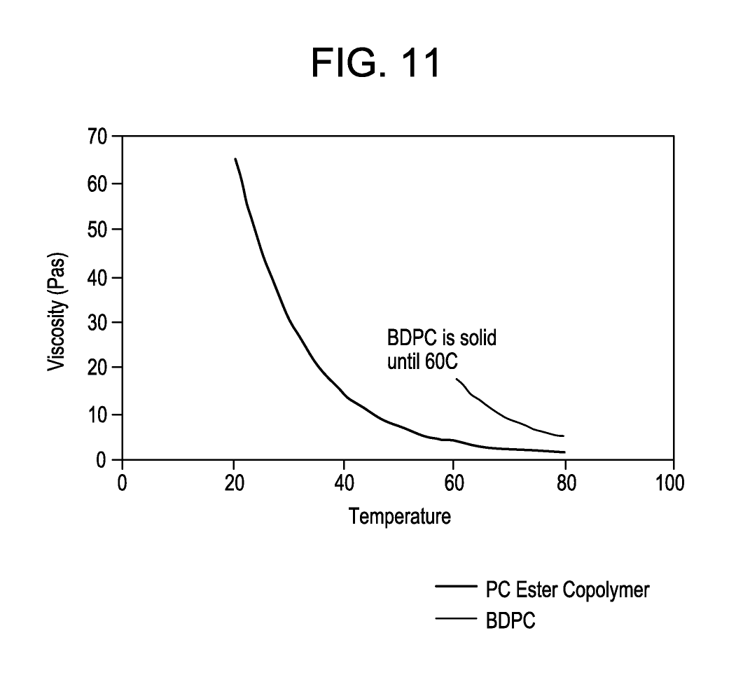

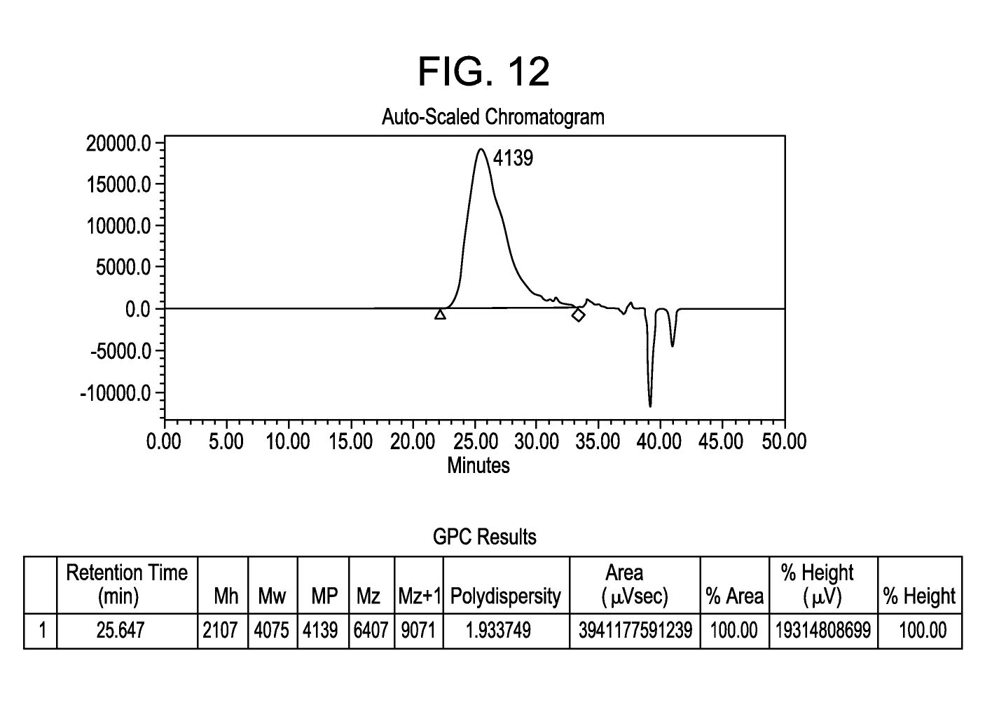

BDPC is a crystalline material and is solid at room temperature (MP˜60 degrees Celsius). Stepanpol AA60 is liquid polyester. The physical blend of polycarbonate and polyester is a waxy solid while the polyester-polycarbonate copolymer is liquid at room temperature. Generally, liquid polyols are easier to process compared to solid materials. The viscosity of polyester-polycarbonate copolymer is shown in FIG. 11. The viscosity of the polyester-polycarbonate copolymer even at higher temperatures (e.g. >60 degrees Celsius) is lower than BDPC. The GPC plot of such copolymer shown in FIG. 12 indicates that the Mn based on PEG standard is approximately 2100. This is very close to Mn calculated from OH# (56)˜2000.

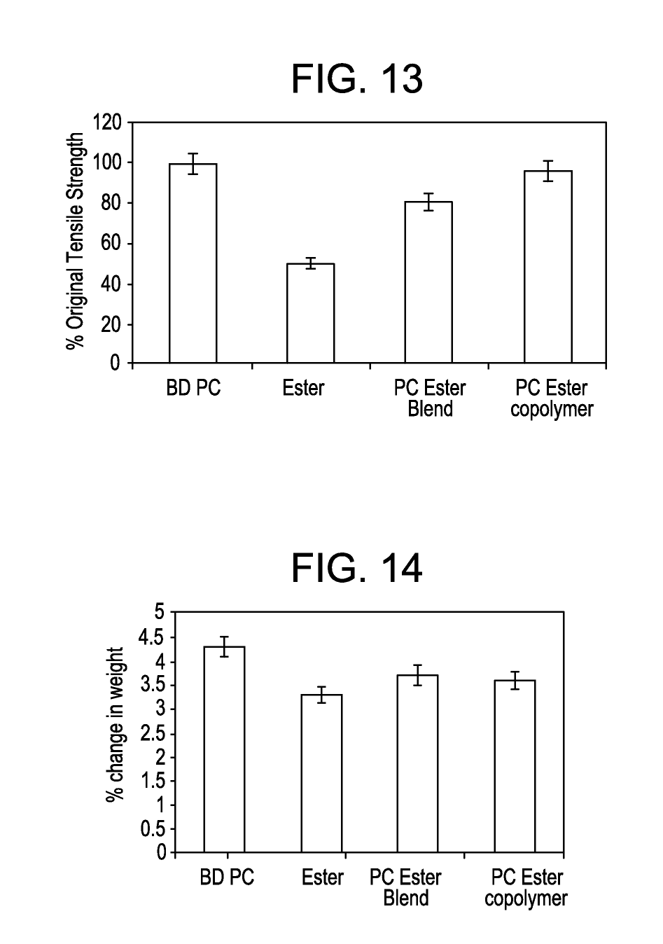

As shown in FIG. 13, the tensile properties of pure polyester (Comparative sample B) dropped by ˜50% after diesel ageing while that of the BDPC (Comparative sample A) and the PC ester copolymer (Example 1) were close to their original values. The physical blend of polycarbonate and polyester (Comparative sample C) showed a 20% drop in tensile strength. As shown in FIG. 14, the diesel uptake was lowest for pure polyester ˜3.3% versus 4.3% for pure BDPC.

Based on the above data polyester-polycarbonate polyols behaves very similarly to pure BDPC in the diesel ageing test. Advantageously, the polyol is a liquid.

While the foregoing is directed to embodiments of the invention, other and further embodiments of the invention may be devised without departing from the basic scope thereof.

What is claimed is:

1. A hydrophilic polyester-polycarbonate polyol which is the reaction product of:
(a) a polyester polyol which is the reaction product of:
(i) one or more organic acids; and
(ii) one or more glycols having a functionality of two or more; and
(b) one or more polycarbonate polyols.

2. The hydrophilic polyester-polycarbonate polyol of claim 1, wherein the one or more organic acids are selected from phthalic acid, isophthalic acid, terephthalic acid, trimellitic acid, tetrahydrophthalic acid, hexahydrophthalic acid, tetrachlorophthalic acid, oxalic acid, adipic acid, azelaic acid, sebacic acid, succinic acid, malic acid, glutaric acid, malonic acid, pimelic acid, suberic acid, 2,2-dimethylsuccinic acid, 3,3-dimethylglutaric acid, 2,2-dimethylglutaric acid, maleic acid, fumaric acid, itaconic acid, fatty acids, and combinations thereof.

3. The hydrophilic polyester-polycarbonate polyol of claim 2, wherein the one or more glycols having a functionality of two or more are selected from ethylene glycol, propylene glycol-(1,2) and -(1,3), diol-(1,8), neopentyl glycol, cyclohexane dimethanol (1,4-bis-hydroxymethylcyclohexane), 2-methyl-1,3-propane diol, glycerine, trimethylolpropane, hexanetriol-(1,2,6) butane triol-(1,2,4), trimethylolethane, pentaerythritol, quinitol, mannitol and sorbitol, methylglycoside, also diethylene glycol, triethylene glycol, tetrathylene glycol, polyethylene glycols, dibutylene glycol, polybutylene glycols, and combinations thereof.

4. The hydrophilic polyester-polycarbonate polyol of claim 1, wherein the one or more organic acids is adipic acid and the one more glycols is glycerin and diethylene glycol.

5. The hydrophilic polyester-polycarbonate polyol of claim 1, wherein the one or more polycarbonates comprise:
(a) repeating units from one or more alkane diols having 2 to 50 carbon atoms with a number average molecular weight between 500 and 3,000; and
(b) at least one carbonate compound selected from alkylene carbonates, diaryl carbonates, dialkyl carbonates, dioxolanones, hexanediol bis-chlorocarbonates, phosgene, urea, and combinations thereof.

6. The hydrophilic polyester-polycarbonate polyol of claim 5, wherein the one or more alkane diols is selected from 1,4-butanediol, 1,5-pentanediol, 1,6-hexandiol, 1,7-heptanediol, 1,2-dodecanediol, cyclohexanedimethanol, 3-methyl-1,5-pentanediol, 2,4-diethyl-1,5-pentanediol, bis(2-hydroxyethyl)ether, bis(6-hydroxyhexyl)ether or short-chain C₂, C₃ or C₄ polyether diols having a number average molecular weight of less than 700 g/mol, and combinations thereof.

7. The hydrophilic polyester-polycarbonate polyol of claim 6, wherein the at least one carbonate compound is selected from alkylene carbonates, diaryl carbonates, dialkyl carbonates, dioxolanones, hexanediol bis-chlorocarbonates, phosgene or urea.

8. A hydrocarbon resistant prepolymer or elastomer prepared from a reaction mixture comprising:
(a) a hydrophilic polyester-polycarbonate polyol; and
(b) one or more organic polyisocyanate components.

9. The hydrocarbon resistant elastomer of claim 8, wherein the reaction mixture further comprises:
(c) one or more chain extenders.

10. The prepolymer or elastomer of claim 8, wherein the hydrophilic polyester-polycarbonate polyol comprises:
(i) a polyester polyol which is the reaction product of:
one or more organic acids; and
one or more glycols having a functionality of two or more
(ii) one or more polycarbonate polyols.

11. The prepolymer or elastomer of claim 10, wherein the one or more organic acids is adipic acid and the one more glycols is glycerin and diethylene glycol.

12. The prepolymer or elastomer of claim 8, wherein the one or more organic polyisocyanate components are selected from polymeric polyisocyanates, aromatic isocyanates, cycloaliphatic isocyanates, or aliphatic isocyanates.

13. The prepolymer or elastomer of claim 12, wherein the one or more organic polyisocyanate components is a polymethylene polyphenylisocyanate that contains diphenylmethane diisocyanate (MDI).

14. An article comprising the prepolymer or elastomer of claim 8.

15. The article of claim 14, wherein the article is selected from filter caps, conduits, containers, seals, mechanical belts, liners, coatings, rollers and machine parts.

16. A coating, adhesive or binding composition formed from the prepolymer or elastomer of claim 8.
